(19) United States
(12) Patent Application Publication
(10) Pub. No.: US 2002/0130773 A1
(43) Pub. Date: Sep. 19, 2002

(54) Method and apparatus used for installation and operation of a front windshield mounted vehicle brake light

(76) Inventors: Cathy D. Santa Cruz, Reno, NV (US); James L. Vasko, Reno, NV (US)

Correspondence Address: Cathy D. Santa Cruz, 7630 Tholl Drive, Reno, NV, 89506, US

(21) Appl. No.: 10/152,275

(22) Filed: May 20, 2002

Related U.S. Application Data
(63) Continuation-in-part of application No. 09/708,211, filed on Nov. 6, 2000.

(51) Int. Cl. B60Q 1/44

(52) U.S. Cl. 340/479; 340/463

(57) ABSTRACT

An accessory front mounted vehicle brake light that is used in combination with the typical brake light electrical system and front windshield of a vehicle including a method for installing the light without adding any electrical components other than one jumper cable. Whereby, when the light is installed and the vehicle brakes are applied, the accessory light will automatically illuminate simultaneously with the rear brake lights, so as to notify pedestrians or other drivers when viewing the front of the vehicle that the host vehicle is in a braking mode.

This application is a continuation in part of patent application Ser. No. 09/708,211 filed on Nov. 6, 2000, entitled “method and apparatus used for installation and operation of a front vehicle brake light” and is now abandoned.

### FIELD OF THE INVENTION

This invention relates in general to vehicle brake light systems, but more specifically pertains to an accessory light which may be mounted at any location of user choice onto the front windshield of a vehicle, such as centrally inside the cab onto the interior surface of the front windshield, or the like. Thus, the accessory light when installed signals to pedestrians and/or to other drivers, that the driver of the vehicle is actively braking. Also included is a simplified method of utilizing the pre-existing prior art brake light circuitry to energize and illuminate the light when braking.

### BACKGROUND OF THE INVENTION

In the past a number of attempts have been made to inform other motorists that your own vehicle is turning, stopping, accelerating, or decelerating and most often this is accomplished by use of lights, such as red stop lights, amber turn lights, etc. Some examples of vehicle lighting systems include U.S. Pat. No. 3,702,459 which teaches a vehicle deceleration circuit, the driver's communication system of U.S. Pat. No. 3,784,974 and U.S. Pat. No. 5,537,091 entitled method of providing a pedestrian signal system for vehicles.

Another example of a vehicle lighting system includes U.S. Pat. No. 4,940,962. However, this reference requires a complicated apparatus and multiple switches, including the addition of extra multiple lights on the front of the vehicle. Also, U.S. Pat. No. 5,025,245 teaches a pedestrian signal system for automobiles wherein they teach an automatic timer and a dash mounted push button switch. Unfortunately, this is most inconvenient as one hand must be taken off the steering wheel to activate the switch and this is not only frustrating for the driver but it could be potentially very dangerous as well.

Still a further attempt is exemplified within U.S. Pat. No. 3,252,136, wherein taught is a signaling system for automobiles, this reference again clearly teaches multiple front and rear lights which are of different colors and which are activated by involved circuitry.

U.S. Pat. No. 5,537,091 issued to James L. Vasko who is one of the present applicants, overcomes the complicated circuitry and addresses the noted drawbacks of the prior art and teaches a method of providing a pedestrian signal system for vehicles which utilizes the existing lights on the vehicle and existing prior art circuitry to provide a pedestrian signal on the front of the vehicle to indicate braking as well as turning. This reference does not teach an apparatus but is simply a method which allows the user to affix proper “jumper cables between the existing circuitry” to achieve the unusual results of having the front turn signals function as stop light indicators as well as turn signals. It is to be noted that the method as taught therein is incorporated herein and is hereafter referred to as the prior art.

However, the present application now eliminates each of the jumper cables used to tie together the rear lamp wire leads and the front lamp wire leads, and we now use one jumper cable which is installed at a location of choice within the pre-existing associated circuitry to energize a new light apparatus, rather than energizing the front lamp wire leads, as taught within the noted prior art, with the light apparatus being positioned and affixed at a location of engineering choice, such as onto the inside surface of the front windshield, or the like.

It is contended by the applicants that the noted prior art reference is complete in itself for energizing a vehicles front brake lights, however, we believe that conventional brake lights as taught, do not attract or grasp the attention from a pedestrians and/or other drivers as efficiently as a “front mounted brake light”.

### SUMMARY OF THE INVENTION

It is therefore a primary object of the present invention to provide a method for energizing a front mounted brake light, with the brake light being attachable onto the front of a vehicle at a location of user choice, such as onto the inside surface of the front windshield, so as to attract the attention of pedestrians which may be passing in front thereof Therefore, the light will automatically indicate to the pedestrians that the vehicle is in a braking mode. As a result this will save many, many lives.

It is a further object of the present invention to utilize the pre-existing prior art brake light circuitry in combination with only one additional jumper cable to energize and activate the above noted light.

It is another object of the present invention to provide a method for installing a prior art light apparatus that uses the pre-existing prior art wiring in a new and unobvious manner to notify pedestrians that the host vehicle is in a braking mode.

It is another object of the present invention to provide a schematic which will instruct the user as to the proper various connection points for installing and connecting a jumper cable between the existing brake light circuitry and the new light apparatus.

Still another object of the present invention is to provide a method for installing a jumper cable within the existing brake light circuitry which will not interfere with the normal functions of the brake lights, turn signal lights, and/or parking lights, etc.

Yet another object of the present invention is to provide a method which allows a workman to install a jumper cable within the existing brake light circuitry which will energize substantially any prior art light apparatus of choice.

Still another object of the present invention is to provide a method which alters the existing brake light circuitry so as to energize and illuminate the new light apparatus simultaneously when the brake pedal is pressed and/or engaged.

Yet another object of the present invention is to provide alternative energizing means for energizing the noted new light apparatus which may eliminate unnecessary wiring, such as the light may be solar powered, battery powered, activated by a photo sensor switch in connection with a motion detector, or even an electrically conductive chemical, etc.

A further object of the present invention is to provide an accessory front mounted brake light apparatus which can be mounted using any suitable attachment means of engineering choice, such as a removable adhesive strip, a loop and pile fastener such as VELCRO, two-sided tape, Silicone, glue, a special bracket, or it may be magnetically attached, etc.

Yet a further object of the present invention is to provide a new and improved light apparatus which overcomes the inherent drawbacks and disadvantages associated with the known prior art. For example, most of the previous attempts to provide a suitable light have failed because they are not easy to install, they include complicated circuitry as well as complex mounting means, and they are not aesthetically pleasing when viewed. Therefore, within the present invention we have addressed these problems and resolved them in a manner heretofore not taught. Also, the present invention includes the light being amber in color which proves to be most effective, aesthetically very pleasing, and most importantly amber colored lights comply with traffic codes and safety regulations, thus amber lights are legal.

Still another object of the present invention is to provide a front mounted vehicle brake light which can be easily mounted onto substantially any type of front windshield, irrespective of the window angle which is very important.

A further object of the present invention is to provide a front mounted vehicle brake light which can be easily seen when viewed substantially from any frontal position of the vehicle, as well as partially seen when viewed from the front sides of the vehicle, unlike any of the known prior art which is only visible when viewed from a position directly in front of the vehicle. This is accomplished by the present invention having a very wide viewing angle up to 70° by 45°, respectively.

Yet another important object of the present invention is to provide a front mounted vehicle brake light which will not interfere with the drivers and/or occupants visibility.

Still further another object of the present invention is to provide a front mounted vehicle brake light which includes a means for allowing the light to be pivotably adjusted and then affixed in place at the desired angle of user choice.

Also another object of the present invention is to provide a front mounted vehicle brake light which is very visible when viewed either during the daytime hours or during the nighttime hours.

A further object of the present invention is to provide a front mounted vehicle brake light which includes multiple light emitting diodes which are covered in an amber colored lens and which are also pulsed. This is very important as it reduces overheating or burnout of the LED's. Also we may include a shade so as to reduce convection cooling in the housing, unlike the known prior art which has not addressed or more particularly resolved this problem.

Still another object of the present invention is to provide a front mounted vehicle brake light which when installed does not need a front lens thereon, as the windshield functions in itself as a lens, particularly because most windshields are tinted which is most advantageous.

### BRIEF DESCRIPTION OF THE DRAWINGS

FIG. 1 is substantially a schematic which depicts the typical prior art brake light circuitry.

FIG. 2 is substantially a schematic which depicts a first embodiment for the brake light circuitry including the present invention.

FIG. 3 is substantially a schematic which depicts a second embodiment for the brake light circuitry including the present invention.

FIG. 4 is substantially a schematic which depicts a third embodiment for the brake light circuitry including the present invention.

FIG. 5 is substantially a schematic which depicts a fourth embodiment for the brake light circuitry including the present invention.

FIG. 6 is substantially a schematic which depicts one arrangement for the light emitting diodes and associated circuitry.

FIG. 7 is substantially illustrative of the projected appropriate light wavelength.

FIG. 8 is substantially a perspective view of the preferred embodiment for the light of the present invention.

FIG. 9 is substantially a side view of the light when mounted onto a bracket.

FIG. 10 is substantially a front view of the bracket of FIG. 9, without the light.

### DETAILED DESCRIPTION OF THE DRAWINGS

Referring now in detail to the drawings wherein like characters refer to like elements throughout the various views. It is to be noted that the schematic as shown within FIG. 1 represents the typical prior art circuitry as installed within most vehicles of present day, wherein (10) represents a left hand parking/directional signal lamp with lead, while (12) represents a right hand parking/directional signal lamp with lead, with (14) being a left hand tail, stop/directional signal lamp with lead, with (15) being a right hand tail, stop/directional signal lamp with lead and (16) being a third rear mounted stop lamp with lead which has been required since the mid nineties.

Further shown within FIG. 1, (18) represents a prior art conventional stop lamp switch with lead and/or brake pedal, with (20) being an in-line fuse, with (19) being a prior art conventional directional signal switch while (22) is a flasher and (24) is a power source battery.

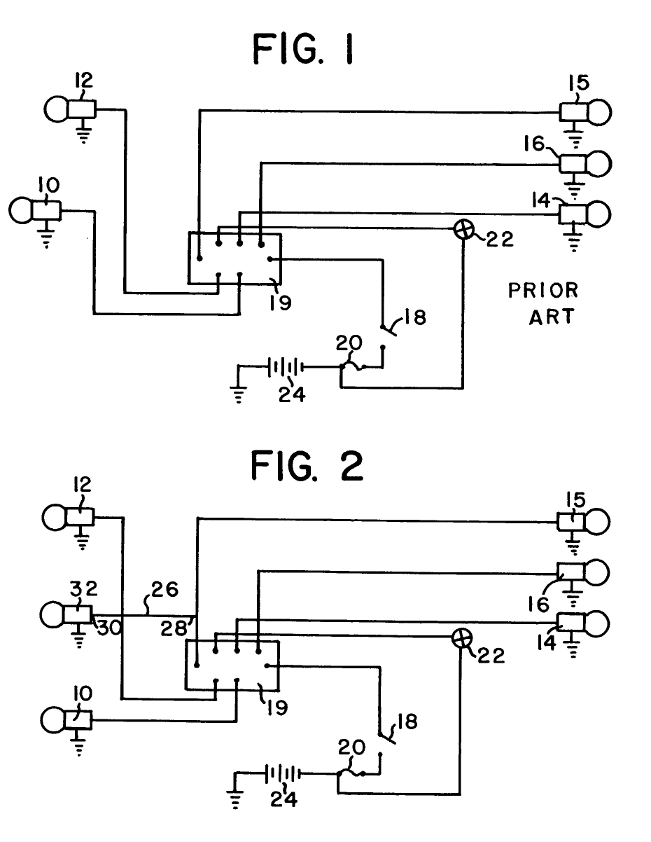

Referring now to FIG. 2, wherein we now show a first schematic which represents the present invention and/or method when installed. It is to be noted that each of the elements as described above and referenced by numerals (10-24) remain the same and function in the usual manner. Thus, the specification hereafter describes how the present invention can be installed in various ways within the pre-existing circuitry to accomplish the desired end result of illuminating an additional front mounted brake light when the normal brakes are engaged.

As illustrated in FIG. 2, we now include a jumper cable (26) having a first end (28) that is electrically connected to the right hand tail stop/directional signal lamp with lead (15) and a second end (30) which is electrically connected to the new front brake light with lead (32) of the present invention. Whereby, when the right hand tail stop/directional signal lamp with lead (15) is activated, the new front brake light with lead (32) is also activated, thus each illuminate simultaneously.

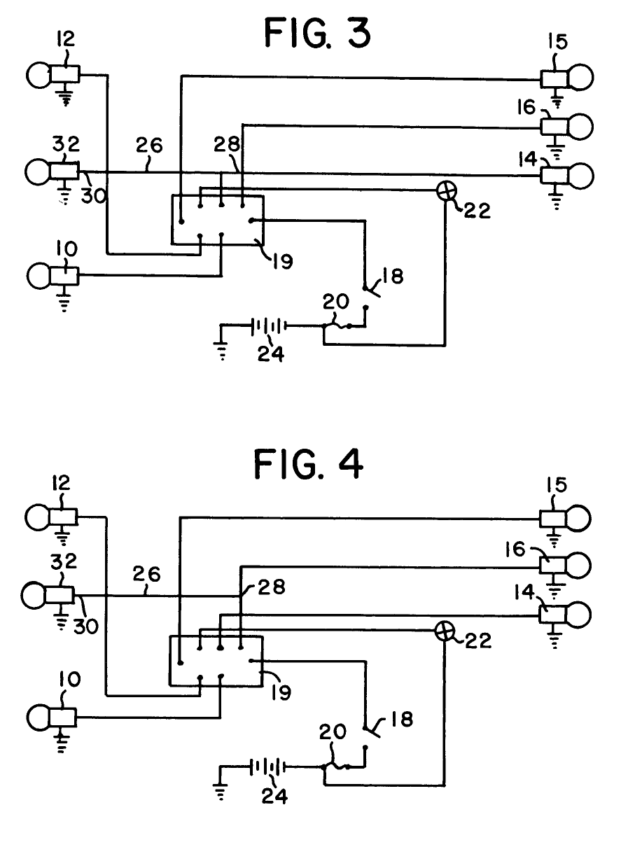

A second embodiment is depicted in FIG. 3, wherein we now include a jumper cable (26) having a first end (28) that is electrically connected to the left hand tail stop signal lamp with lead (14) and a second end (30) which is electrically connected to the new front brake light with lead (32) of the present invention. Whereby, when the left hand tail stop/directional signal lamp with lead (15) is activated, the new front brake light with lead (32) is also activated, thus each illuminate simultaneously.

A third embodiment is depicted in FIG. 4, wherein we now include a jumper cable (26) having a first end (28) that is electrically connected to the third rear mounted stop light (16) and a second end (30) which is electrically connected to the new front brake light with lead (32) of the present invention. Whereby, when the third rear mounted stop lamp (16) is activated, the new front brake light with lead (32) is also activated, thus each illuminate simultaneously.

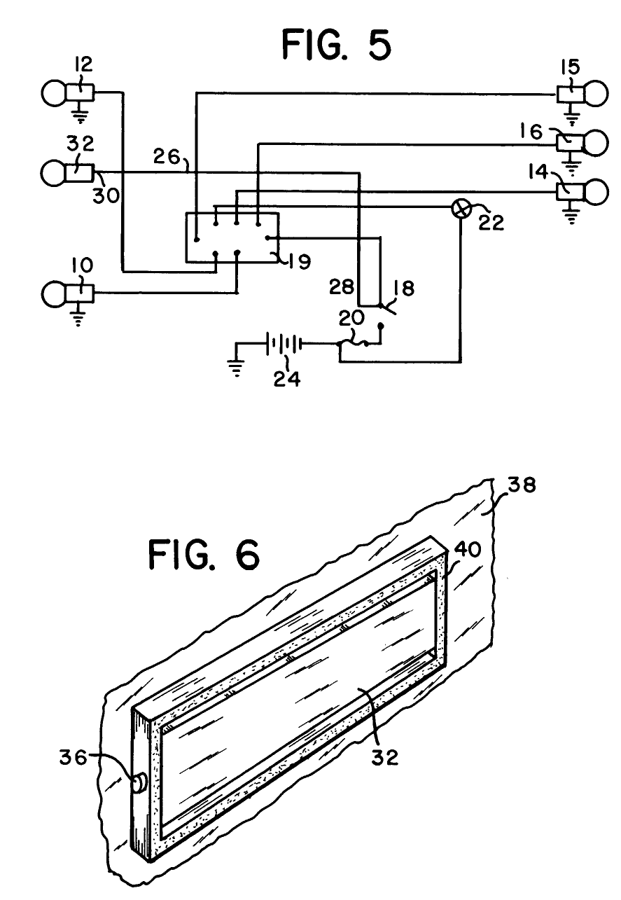

A fourth embodiment is depicted in FIG. 5, wherein we now include a jumper cable (26) having a first end (28) that is electrically connected to the conventional stop lamp switch/pedal (18) and a second end (30) which is electrically connected to the new front brake light with lead (32) of the present invention. Whereby, when the conventional stop lamp switch/pedal (18) is activated/pressed, the new front brake light with lead (32) is also activated, thus each operate simultaneously.

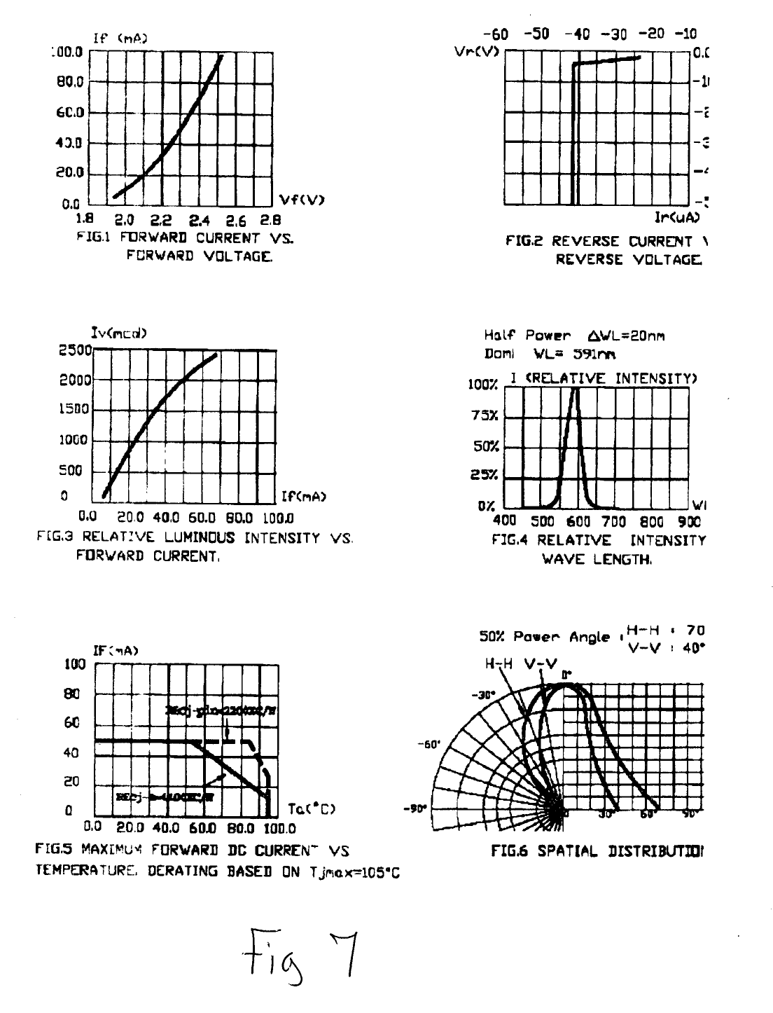

Referring now to FIG. 6 wherein we depict one example of a suitable schematic for the light emitting diodes (33) and the appropriate circuitry for activation thereof. It is to be understood this is only exemplary of one schematic and the invention is not to be limited thereto. For example, the schematic may include any suitable amount of diodes of engineering choice.

In reference to FIG. 7, this illustrates the unique and novel projected appropriate light wavelength accomplished by the present accessory front mounted vehicle brake light (32). However, the particulars are not discussed herein as the drawings are self-explanatory, respectively.

It is to be noted that the new front brake light with lead (32) of the present invention may be any suitable light and light source of engineering choice so long as it can be grounded (not shown) and includes a wire lead there from. Therefore the following description is only an example of one possible embodiment for the new accessory front mounted vehicle brake light of the present invention.

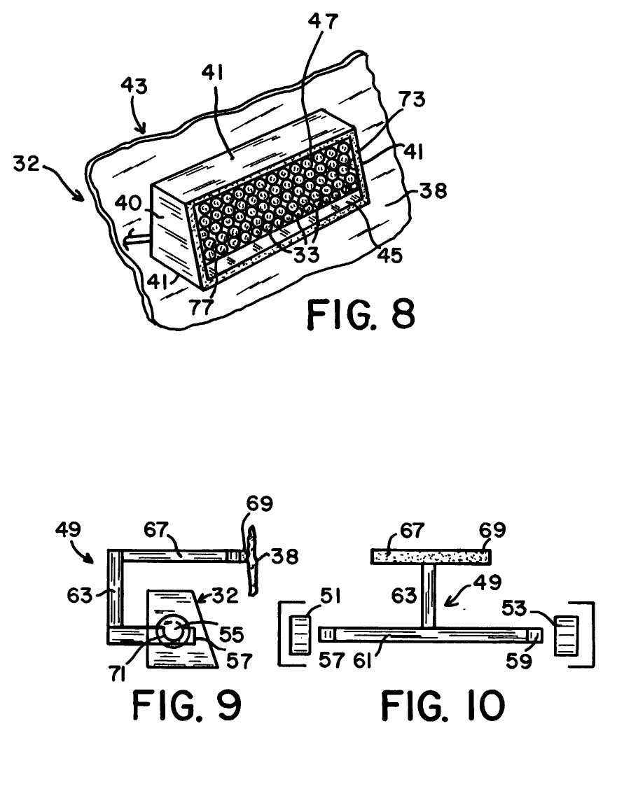

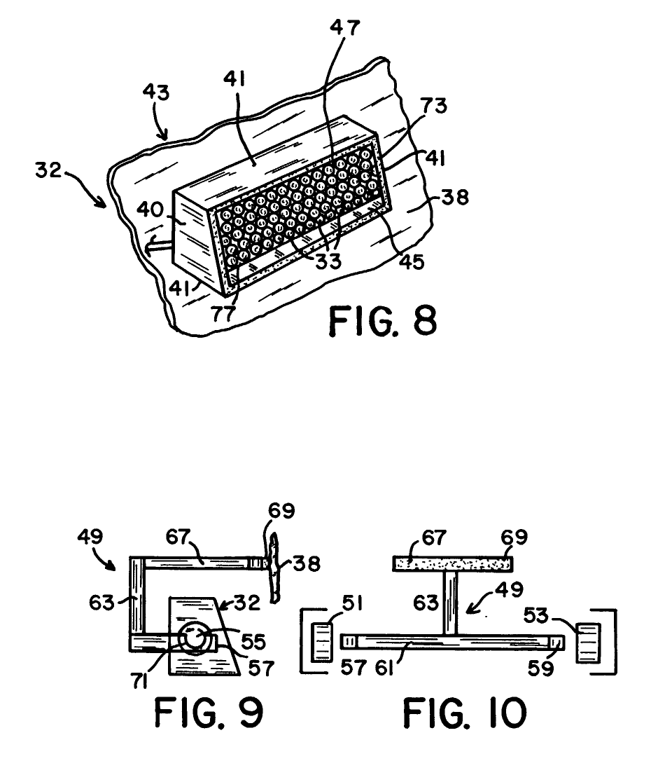

Referring now to FIG. 8, wherein we show the preferred embodiment for the new front brake light with lead (32) of the present invention which substantially comprises the following. An accessory front mounted vehicle brake light (32) which is to be used with the pre-existing brake light electrical system and the front windshield (38) in combination. The accessory front mounted vehicle brake light (32) is substantially formed from a housing (40) which includes four sidewalls (41) which are interconnected to a rear wall (43) and in combination define a frontally exposed open compartment (45) which is used for containment of the light source (47). It is to be understood the housing (40) can be made from substantially any suitable material of engineering choice, such as plastic or the like and further functions to protect the occupants from any back-lighting which could be distracting to the driver.

Also, depending on engineering choice, the four sidewalls (41) may be angled so as to mate with the interior surface of the front windshield (38). Thus, different housings having different angular sidewalls may be produced and offered to the consumer. Furthermore, housing (40) includes attachment means thereon for removably attaching the housing (40) onto the interior surface of front windshield (38) of a vehicle which will later be addressed and described herein. It is to be understood in this embodiment, the front windshield (38) also functions as a lens cover for frontally exposed open compartment (45).

As depicted in FIGS. 9 & 10, we provide one possible means for removably attaching housing (40) onto the interior surface of windshield (38) which also allows the user to install the accessory front mounted vehicle brake light (32), and then adjustably pivotably position the light into a desired position and then secure in place when adjusted. For example, one suitable pivotable attachment means includes the use of a bracket (49) and first and second end cap members (51 & 53). Housing (40) further having a first outwardly protruding pin and a second outwardly protruding pin (55), with first outwardly protruding pin being substantially opposed to the second outwardly protruding pin. Please note only one pin (55) is depicted in FIG. 9 for clarity purposes but two pins are herein taught.

Bracket (49) can be made of any suitable material of engineering choice, such as plastic or the like. Bracket (49) substantially comprising of a first horizontal short leg (57), a second horizontal short leg (59), a horizontal connecting leg (61) for connecting first horizontal short leg (57) and second horizontal short leg (59) thereon in an opposed manner. Bracket (49) further having a vertical uprising leg (63) which is interconnected centrally onto horizontal connecting leg (61), and a horizontal T-shaped leg (67) formed from a long leg and two short attachment legs, with the long leg being interconnected to vertical uprising leg (63) substantially in a central position and the two short legs having appropriate attachment means thereon, such as a removable adhesive strip (69) thereon for removably attaching bracket (49) onto the interior surface of front windshield (38).

Further depicted in FIG. 9, first horizontal short leg (57) includes a partial cutout (71) which is of a shape and size to slidably removably receive first outwardly protruding pin (55) therein. Second horizontal short leg (59) includes a partial cutout (71) which is of a shape and size to slidably removably receive second outwardly protruding pin therein. Furthermore, first end cap member (51) is of a shape and size to slidably receive first outwardly protruding pin (55) therein, and second end cap member (53) is of a shape and size to slidably receive second outwardly protruding pin (55) therein. Whereby, accessory front mounted vehicle brake light (32) can be easily positioned in between first horizontal short leg (57) and second horizontal short leg (59) in a pivotable manner, thus accessory front mounted vehicle brake light (32) can be easily pivotably adjusted into a desired position and then secured in place by each end cap member (51 & 53).

As previously noted, housing (40) includes suitable attachment means of engineering choice for mounting the light (32) at the desired location onto the interior surface of front windshield (38). It is to be understood any suitable attachment means of choice may be used, such as a loop and pile fastener like VELCRO, two-sided tape, Silicone, glue, or it may be magnetically attached, etc. Or as the applicants prefer, the housing (40) may be easily attached onto a mounting surface, such as onto the inside surface of the windshield (38) of the vehicle, by a peel-a-way adhesive strip (73), which leaves a sticky residue and allows the light (32) to remain in place without harming are marring the mounting surface.

As previously noted any type of internal light source of engineering choice may be used, however the following light source is preferred. Wherein the light source comprises a circuit board (77) having installed thereon multiple light emitting diodes (33) and appropriate circuitry for activation of multiple light emitting diodes (33), with multiple light emitting diodes (33) being pulsed, and each of the multiple light emitting diodes (33) include a tinted diffused lens, with the lens being substantially amber in color. However, it is to be understood amber light is noted at a wavelength of 590 nm. The present LED's shine at a wavelength of 594 which is closer to orange than yellow. Yellow light is noted at a wavelength of 580 nm. Orange light is noted at a wavelength of 600 nm.

It is to be noted that if so desired the workman may utilize the existing wiring arrangement using any of the rear brake lamp tail leads to illuminate multiple lights and/or the lights may be arranged in series, (not shown).

It will now be seen that within the following specification we now provide a first method for energizing an accessory front mounted vehicle brake light utilizing existing circuitry installed within a vehicle, comprising: a stop lamp switch circuit, a right rear brake signal lamp with lead, a left rear brake signal lamp with lead, an in-line fuse, a flasher, a battery, and an accessory front mounted vehicle brake light which is formed from a housing having an internal light source and the housing having an electrical lead extending there from, with the electrical lead being electrically connected to light source, and housing having attachment means thereon for removably attaching housing onto a front windshield of a vehicle, with the method comprising the steps of:

a. positioning housing (40) onto windshield (38) at a preferred location;

b. attaching housing (40);

c. locating a right rear brake signal lamp lead (12);

d. locating electrical lead (32); and

e. affixing a jumper cable (26) between c and d;

whereby;

when stop lamp switch circuit is activated, each rear brake signal lamp and accessory front mounted vehicle brake light will simultaneously illuminate.

We now provide a second method for energizing an accessory front mounted vehicle brake light utilizing existing circuitry installed within a vehicle, comprising: a stop lamp switch circuit, a right rear brake signal lamp with lead, a left rear brake signal lamp with lead, an in-line fuse, a flasher, a battery, and an accessory front mounted vehicle brake light which is formed from a housing having an internal light source, said housing having an electrical lead extending there from, said electrical lead being electrically connected to light source, and housing having attachment means thereon for removably attaching housing onto a front windshield of a vehicle, with the method comprising the steps of:

a. positioning housing (40) onto windshield (38) at a preferred location;

b. attaching housing (40);

c. locating left rear brake signal lamp lead (14);

d. locating electrical lead (32); and

a. affixing a jumper cable (26) between c and d;

whereby;

when stop lamp switch circuit is activated, each rear brake signal lamp and accessory front mounted vehicle brake light will simultaneously illuminate.

The following is a third method used for installing and energizing an accessory front mounted vehicle brake light utilizing existing circuitry installed within a vehicle, comprising: a left hand parking/directional signal lamp with lead, a right hand parking/directional signal lamp with lead, a left hand tail stop/directional signal lamp with lead, a right hand tail stop/directional signal lamp with lead, a third rear mounted stop light with lead, a prior art conventional stop lamp switch with lead and/or brake pedal, an in-line fuse, a prior art conventional directional signal switch, a flasher, a battery, and an accessory front mounted vehicle brake light which is formed from a housing having an internal light source, housing having an electrical lead extending there from, with electrical lead being electrically connected to light source, and housing having attachment means thereon for removably attaching said housing onto a front windshield of a vehicle, with the method comprising the steps of:

a. positioning housing (40) onto windshield (38) at a preferred location;

b. attaching housing (40);

c. locating third rear mounted stop light with lead (16);

d. locating electrical lead (32); and

e. affixing a jumper cable (26) between c and d;

whereby;

when stop lamp switch with lead and/or brake pedal is activated, each tail lamp, third rear mounted stop light with lead, and accessory front mounted vehicle brake light will simultaneously illuminate.

The following is a fourth method used for installing and energizing an accessory front mounted vehicle brake light utilizing existing circuitry installed within a vehicle, comprising: a left hand parking/directional signal lamp with lead, a right hand parking/directional signal lamp with lead, a left hand tail stop/directional signal lamp with lead, a right hand tail stop/directional signal lamp with lead, a third rear mounted stop light with lead, a prior art conventional stop lamp switch with lead and/or brake pedal, an in-line fuse, a prior art conventional directional signal switch, a flasher a battery and an accessory front mounted vehicle brake light which is formed from a housing having an internal light source, housing having an electrical lead extending there from, electrical lead being electrically connected to said light source, and housing having attachment means thereon for removably attaching said housing onto a front windshield of a vehicle, with the method comprising the steps of:

a. positioning housing (40) onto windshield (38) at a preferred location;

b. attaching housing (40);

c. locating prior art conventional stop lamp switch with lead and/or brake pedal (18);

d. locating electrical lead (32); and

e. affixing a jumper cable (26) between c and d;

whereby;

when stop lamp switch with lead and/or brake pedal is activated, each tail lamp, said third rear mounted stop light with lead, and said accessory front mounted vehicle brake light will simultaneously illuminate.

It will now be seen that we have herein provided multiple methods for energizing an accessory front mounted vehicle brake light, with the light being attachable onto the front windshield of the vehicle at a location of installer choice, so as to attract the attention of pedestrians which may be passing in front thereof, and therefore indicate to the pedestrians and other drivers that the vehicle is in a braking mode.

It will further be seen that we have herein provided multiple methods which utilize the existing prior art brake light circuitry found within a vehicle to energize and illuminate the above noted light.

It will also be seen that we have herein provided a method for installing an accessory front mounted vehicle brake light which uses the existing prior art wiring in a new and un-obvious manner heretofore not seen, to notify pedestrians that the host vehicle is in a braking mode.

It will also be seen that no additional performance from the driver is required as all ordinary functions regarding the electrical system, namely the lights, have not been altered and therefore, the newly installed vehicle light automatically works when the driver steps on the brake pedal.

It will also be seen that this method can be performed and/or installed at the site of manufacture, or it can be performed and/or installed by an installer or the owner of the vehicle at a later date.

It will further be seen that we have herein provided an accessory front mounted vehicle brake light which notifies pedestrians, or other on-coming drivers that the vehicle is braking.

It will further be seen that we have herein provided an accessory front mounted vehicle brake light which if it becomes mandatory, will reduce accidents between vehicles and reduce accidents involving pedestrians.

It will further be seen that we have herein provided an accessory front mounted vehicle brake light which works in unison with the turn signals and the brake lights, thus oncoming traffic can easily tell that the vehicle is actually braking and will most likely be turning in the direction of the signal light.

It will further be seen that we have herein provided an accessory front mounted vehicle brake light whereby during an emergency stop, the driver can look in their rear view mirror and see if the vehicle behind them is also braking.

It will further be seen that we have herein provided an accessory front mounted vehicle brake light which notifies other motorists and pedestrians that the vehicle is stopped, such as during a red light at a stop light intersection. Whereby, pedestrians and other vehicles are assured that the host vehicle will not abruptly enter the intersection because their foot is actively engaged on the brake pedal.

It will further be seen that we have herein provided an accessory front mounted vehicle brake light which is especially useful when an emergency vehicle is approaching the host vehicle, as the driver of the emergency vehicle can tell that the host vehicle is actively braking or is stopped. Whereby reducing accidents with emergency vehicles, this further saves lives and improves response time.

It will further be seen that we have herein provided an accessory front mounted vehicle brake light which will reduce accidents associated with drivers who run red lights, as the other drivers will automatically know that the vehicle is not stopping.

It will further be seen that we have herein provided an accessory front mounted vehicle brake light which will help the driver when merging into traffic, as the driver can tell if the other drivers are going to let the oncoming vehicle onto the roadway because they see that the front brake light is on.

It will further be seen that we have herein provided an accessory front mounted vehicle brake light which is helpful in dark areas, such as when parking in a garage as the light will further illuminate the surrounding area.

It is to be noted that with today's ever growing advancements in electronics, the accessory front mounted vehicle brake light may be installed onto the front of a vehicle without complicated wiring. Such as the light may be actuated or powered by batteries, solar power, chemical compositions which are electrically conductive, etc., and thus such technology is to be incorporated herein.

Although the invention has been shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described our invention, what we claim as new and desire to secure by Letters Patent is:

1. A method used for installing and energizing an accessory front mounted vehicle brake light utilizing existing circuitry installed within a vehicle, comprising: a stop lamp switch circuit, a right rear brake signal lamp with lead, a left rear brake signal lamp with lead, an in-line fuse, a flasher, a battery, and an accessory front mounted vehicle brake light which is formed from a housing having an internal light source, said housing having an electrical lead extending there from, said electrical lead being electrically connected to said light source, and said housing having attachment means thereon for removably attaching said housing onto a front windshield of a vehicle, with said method comprising the steps of:
a. positioning said housing onto said windshield at a preferred location;
b. attaching said housing;
c. locating said right rear brake signal lamp lead;
d. locating said electrical lead; and
e. affixing a jumper cable between c and d;
whereby;
when said stop lamp switch circuit is activated, each said rear brake signal lamp and said accessory front mounted vehicle brake light will simultaneously illuminate.

2. A method used for installing and energizing an accessory front mounted vehicle brake light utilizing existing circuitry installed within a vehicle, comprising: a stop lamp switch circuit, a right rear brake signal lamp with lead, a left rear brake signal lamp with lead, an in-line fuse, a flasher, a battery, and an accessory front mounted vehicle brake light which is formed from a housing having an internal light source, said housing having an electrical lead extending there from, said electrical lead being electrically connected to said light source, and said housing having attachment means thereon for removably attaching said housing onto a front windshield of a vehicle, with said method comprising the steps of:
a. positioning said housing onto said windshield at a preferred location;
b. attaching said housing;
c. locating said left rear brake signal lamp lead;
d. locating said electrical lead; and
a. affixing a jumper cable between c and d;
whereby;
when said stop lamp switch circuit is activated, each said rear brake signal lamp and said accessory front mounted vehicle brake light will simultaneously illuminate.

3. A method used for installing and energizing an accessory front mounted vehicle brake light utilizing existing circuitry installed within a vehicle, comprising: a left hand parking/directional signal lamp with lead, a right hand parking/directional signal lamp with lead, a left hand tail stop/directional signal lamp with lead, a right hand tail stop/directional signal lamp with lead, a third rear mounted stop light with lead, a prior art conventional stop lamp switch with lead and/or brake pedal, an in-line fuse, a prior art conventional directional signal switch, a flasher a battery and an accessory front mounted vehicle brake light which is formed from a housing having an internal light source, said housing having an electrical lead extending there from, said electrical lead being electrically connected to said light source, and said housing having attachment means thereon for removably attaching said housing onto a front windshield of a vehicle, with said method comprising the steps of:
a. positioning said housing onto said windshield at a preferred location;
b. attaching said housing;
c. locating said third rear mounted stop light with lead;
d. locating said electrical lead; and
e. affixing a jumper cable between c and d;
whereby;
when said stop lamp switch with lead and/or brake pedal is activated, each tail lamp, said third rear mounted stop light with lead, and said accessory front mounted vehicle brake light will simultaneously illuminate.

4. A method used for installing and energizing an accessory front mounted vehicle brake light utilizing existing circuitry installed within a vehicle, comprising: a left hand parking/directional signal lamp with lead, a right hand parking/directional signal lamp with lead, a left hand tail stop/directional signal lamp with lead, a right hand tail stop/directional signal lamp with lead, a third rear mounted stop light with lead, a prior art conventional stop lamp switch with lead and/or brake pedal, an in-line fuse, a prior art conventional directional signal switch, a flasher a battery and an accessory front mounted vehicle brake light which is formed from a housing having an internal light source, said housing having an electrical lead extending there from, said electrical lead being electrically connected to said light source, and said housing having attachment means thereon for removably attaching said housing onto a front windshield of a vehicle, with said method comprising the steps of:
a. positioning said housing onto said windshield at a preferred location;
b. attaching said housing;
c. locating said prior art conventional stop lamp switch with lead and/or brake pedal;
d. locating said electrical lead; and
e. affixing a jumper cable between c and d;
whereby;
when said stop lamp switch with lead and/or brake pedal is activated, each tail lamp, said third rear mounted stop light with lead, and said accessory front mounted vehicle brake light will simultaneously illuminate.

5. An accessory front mounted vehicle brake light which is used in combination with the typical brake light electrical system and front windshield of a vehicle comprising: an accessory front mounted vehicle brake light which is formed from a housing having an internal light source, said housing having an electrical lead extending there from, said electrical lead being electrically connected to said light source, said housing having attachment means thereon for removably attaching said housing onto a front windshield of a vehicle, and a jumper cable which is electrically connected to said electrical lead of said front mounted vehicle brake light and to said typical brake light electrical system of said vehicle,
whereby,
when said typical brake light electrical system of said vehicle is energized, said front mounted vehicle brake light and the existing rear brake lamps on said vehicle will automatically simultaneously illuminate.

6. The accessory front mounted vehicle brake light which is used in combination with the typical brake light electrical system and front windshield of a vehicle of claim 5 wherein said jumper cable which is electrically connected to said electrical lead of said front mounted vehicle brake light and to said typical brake light electrical system of said vehicle is by said jumper cable being installed and electrically connected between said electrical lead of said front vehicle brake light and a left hand tail stop/directional signal lamp with lead of said electrical system.

7. The accessory front mounted vehicle brake light which is used in combination with the typical brake light electrical system and front windshield of a vehicle of claim 5 wherein said jumper cable which is electrically connected to said electrical lead of said front mounted vehicle brake light and to said typical brake light electrical system of said vehicle is by said jumper cable being installed and electrically connected between said electrical lead of said front vehicle brake light and a right hand tail stop/directional signal lamp with lead of said electrical system.

8. The accessory front mounted vehicle brake light which is used in combination with the typical brake light electrical system and front windshield of a vehicle of claim 5 wherein said jumper cable which is electrically connected to said electrical lead of said front mounted vehicle brake light and to said typical brake light electrical system of said vehicle is by said jumper cable being installed and electrically connected between said electrical lead of said front vehicle brake light and a third rear mounted stop lamp with lead of said electrical system.

9. The accessory front mounted vehicle brake light which is used in combination with the typical brake light electrical system and front windshield of a vehicle of claim 5 wherein said jumper cable which is electrically connected to said electrical lead of said front mounted vehicle brake light and to said typical brake light electrical system of said vehicle is by said jumper cable being installed and electrically connected between said electrical lead of said front vehicle brake light and a stop lamp switch with lead of said electrical system.

10. An accessory front mounted vehicle brake light which is used with the pre-existing brake light electrical system and front windshield of a vehicle in combination comprising: an accessory front mounted vehicle brake light which is formed from a housing having an internal light source, said housing having an electrical lead extending there from, said electrical lead being electrically connected to said light source, said housing having attachment means thereon for removably attaching said housing onto the interior surface of a front windshield of a vehicle, and a jumper cable which is electrically connected to said electrical lead of said front mounted vehicle brake light and to said typical brake light electrical system of said vehicle,
whereby,
when said typical brake light electrical system of said vehicle is energized, said front mounted vehicle brake light and the existing rear brake lamps on said vehicle will automatically simultaneously illuminate.

11. The accessory front mounted vehicle brake light which is used with the pre-existing brake light electrical system and front windshield of a vehicle in combination of claim 10 wherein said housing having an internal light source further comprising: said housing having four sidewalls interconnected to a rear wall which in combination define a frontally exposed open compartment for containment of said internal light source, said internal light source being fixedly attached onto said rear wall, said four sidewalls being angled so as to mate with said interior surface of said front windshield, said four sidewalls having said attachment means thereon for removably attaching said housing onto said interior surface of said front windshield, and said front windshield functioning as a lens cover for said frontally exposed open compartment.

12. The accessory front mounted vehicle brake light which is used with the pre-existing brake light electrical system and front windshield of a vehicle in combination of claim 11 wherein said attachment means is two-sided tape.

13. The accessory front mounted vehicle brake light which is used with the pre-existing brake light electrical system and front windshield of a vehicle in combination of claim 11 wherein said attachment means is a two-sided adhesive strip.

14. The accessory front mounted vehicle brake light which is used with the pre-existing brake light electrical system and front windshield of a vehicle in combination of claim 11 wherein said attachment means is glue.

15. The accessory front mounted vehicle brake light which is used with the pre-existing brake light electrical system and front windshield of a vehicle in combination of claim 11 wherein said attachment means is of the loop and pile variety.

16. The accessory front mounted vehicle brake light which is used with the pre-existing brake light electrical system and front windshield of a vehicle in combination of claim 11 wherein said attachment means is Silicone.

17. The accessory front mounted vehicle brake light which is used with the pre-existing brake light electrical system and front windshield of a vehicle in combination of claim 10 wherein said housing having attachment means thereon for removably attaching said housing onto the interior surface of a front windshield of a vehicle, said attachment means comprising: said housing having a first outwardly protruding pin and a second outwardly protruding pin, said first outwardly protruding pin being opposed to said second outwardly protruding pin, a first end cap member and a second end cap member, a bracket having a first horizontal short leg, a second horizontal short leg, a horizontal connecting leg for connecting said first horizontal short leg and said second horizontal short leg thereon in an opposed manner, a vertical uprising leg interconnected centrally onto said horizontal connecting leg, a horizontal T-shaped leg having a long leg and two short attachment legs, said long leg being interconnected to said vertical uprising leg, and said two short legs having attachment means thereon for removably attaching said bracket onto said interior surface of said front windshield, said first horizontal short leg having a partial cutout which is of a shape and size to slidably removably receive said first outwardly protruding pin therein, said second horizontal short leg having a partial cutout which is of a shape and size to slidably removably receive said second outwardly protruding pin therein, said first end cap member being of a shape and size to slidably receive said first outwardly protruding pin therein, and said second end cap member being of a shape and size to slidably receive said second outwardly protruding pin therein,
whereby:
said accessory front mounted vehicle brake light can be easily positioned in between said first horizontal short leg and said second horizontal short leg in a pivotable manner, therefore said accessory front mounted vehicle brake light can be easily pivotably adjusted into a desired position and then secured in place by each said end cap member.

18. The accessory front mounted vehicle brake light which is used with the pre-existing brake light electrical system and front windshield of a vehicle in combination of claim 10 wherein said internal light source comprising: a circuit board having installed thereon multiple light emitting diodes and appropriate circuitry for activation of said multiple light emitting diodes.

19. The accessory front mounted vehicle brake light which is used with the pre-existing brake light electrical system and front windshield of a vehicle in combination of claim 18 wherein said multiple light emitting diodes are pulsed.

20. The accessory front mounted vehicle brake light which is used with the pre-existing brake light electrical system and front windshield of a vehicle in combination of claim 18 wherein said multiple light emitting diodes each include a tinted diffused lens.

21. The accessory front mounted vehicle brake light which is used with the preexisting brake light electrical system and front windshield of a vehicle in combination of claim 20 wherein said tinted diffused lens is the color of amber.
